(19) United States
(12) Patent Application Publication
(10) Pub. No.: US 2009/0224182 A1
(43) Pub. Date: Sep. 10, 2009

(54) Laser Heated Discharge Plasma EUV Source With Plasma Assisted Lithium Reflux

(75) Inventor: Malcolm W. McGeoch, Little Compton, RI (US)

Correspondence Address: WOLF GREENFIELD & SACKS, P.C., 600 ATLANTIC AVENUE, BOSTON, MA, 02210-2206, US

(73) Assignee: PLEX LLC, Fall River, MA (US)

(21) Appl. No.: 12/389,821

(22) Filed: Feb. 20, 2009

Related U.S. Application Data
(60) Provisional application No. 61/066,537, filed on Feb. 21, 2008.

(51) Int. Cl. G01J 3/10

(52) U.S. Cl. 250/504 R

(57) ABSTRACT

A self-magnetically confined lithium plasma that has an applied axial magnetic field is irradiated at sub-critical density by a perpendicularly oriented carbon dioxide laser to generate extreme ultraviolet photons at the wavelength of 13.5 nm with high efficiency, high power and small source size. Lithium reflux is facilitated by ionization, electric field induced drift toward, and capture on surfaces intersected perpendicularly by the applied axial magnetic field.

### CROSS REFERENCE TO RELATED APPLICATION

This application claims priority based on provisional application Ser. No. 61/066,537, filed Feb. 21, 2008, which is hereby incorporated by reference in its entirety.

### BACKGROUND OF THE INVENTION

In order to have a high printing speed in extreme ultraviolet lithography, light at 13.5 nm with a minimum power of 1 kW in a narrow 2% fractional band is required out of the source into a solid angle of 2π steradians [1], with extremely low levels of contaminants and very high reliability. In U.S. patent application Ser. No. 12/277,623 [2] the principle was disclosed of a linear Z-pinch lithium discharge that was locally heated in a short section of its length by a transversely incident carbon dioxide laser beam, Absorption occurred via the inverse bremmstrahlung mechanism, causing local heating of the electrons in the pinch plasma. The local temperature rise, accompanied by thermalization of the absorbed energy, caused a sharply increased excitation of the doubly-ionized lithium resonance transition and increased radiation at 13.5 nm from the small heated volume. This principle allowed the full potential conversion efficiency (up to 30% or more) to be achieved from 10.6 μm laser light to 13.5 nm EUV radiation. However, the prior disclosure only proposed a helium buffered heat pipe based on the “Wide angle heat pipe” principle described in U.S. Pat. No. 7,479,646[3] as the means to contain lithium vapor and prevent it from landing on the necessary EUV collection optical element directly facing the plasma. This gas-buffered heat pipe is only one approach to containing lithium. Another approach, which is the subject of the present application, allows the use of a much lower helium buffer pressure, or even no helium buffer. In addition to this possible advantage, which reduces optical losses to the EUV radiation as it leaves the source, a larger solid angle of emitted radiation can be captured and transmitted to the point of use, referred to as the “intermediate focus” or IF.

EUV sources based on metal vapor plasmas, produced by any means, have to provide a means to capture the metal vapor before it can deposit on the collection optic. A window can not be used to block the metal vapor because absorption in all solid materials is too great at the EUV lithography wavelength of 13.5 nm. Three principal approaches have been used in order to block metal vapor while allowing passage of EUV photons. These are the use of a gas blanket, for example in a gas-buffered heat pipe [3], the use of a magnetic field to divert ionized plasma particles [4], and the use of an electric field to repel charged debris particles [5,6]. These approaches can in principle be used together in various combinations. In regard to the use of a magnetic field in a vacuum, Niimi et al. [4] used laser irradiation of a solid tin target placed in a magnetic field of strength up to 0.6 Tesla, and observed substantial blockage of the expanding tin plasma. The electrostatic method, in a vacuum, was demonstrated by Takenoshita and Richardson [6].

### SUMMARY OF THE INVENTION

In the present invention a new geometry is presented in which a combination of magnetic and electrostatic methods not only enables capture of the lithium metal, but allows its recirculation and recovery for immediate re-use in the plasma BUV source.

The present EUV source [2] overcomes the prior limitations of both DPP and LPP lithium EUV sources by using a hybrid method in which a magnetically confined lithium discharge plasma is laser-heated. This method is termed the “laser-heated discharge plasma” (LHDP). The radiating volume is then defined by the laser spot size and the laser absorption length in the lithium plasma, while lithium is confined and re-circulated so that power scaling does not involve an increase in ejected material that has to be trapped. In fact, the total lithium inventory in this approach can be extremely small. Note that in distinction to prior art the plasma is not laser-produced, but merely laser-heated after being discharge-produced.

Direct laser irradiation of a solid density lithium target gives low conversion efficiency from laser light into EUV radiation because there is only a very thin layer of the laser-produced plasma that is at the correct density and temperature for efficient EUV emission. However, in the LHDP a relatively long absorption length is obtainable if the plasma is arranged to be “underdense” to the incoming laser radiation. In this circumstance, the plasma electron density is less than the critical density for the laser wavelength λ defined by n_{c}=1.1×10²¹/λ² cm³, where λ is in μm. Below the critical density, the dominant laser absorption mechanism in the plasma is the process of inverse bremsstrahlung absorption. By varying the plasma density and temperature, as further discussed below, the absorption length may be tuned to the range of 1 mm or less, corresponding to the ideal EUV source dimension.

The apparatus of the present disclosure comprises a constricted, pulsed, linear lithium discharge of the Z-pinch type intersected at right angles (or a high angle) by a focused laser beam. The plasma subsequently expands and lithium has to be captured and re-circulated, In this case, the “debris” is on the atomic scale and does not contain particles as is the case with laser-irradiated solid density targets (including liquid metal droplets). Lithium vapor has to be contained closely around the discharge because it can damage the EUV collection optic and is generally corrosive to parts of the equipment, particularly insulators. In [2] an axial magnetic field has already been applied in order to stabilize [7] the pulsed Z-pinch plasma, so one means of plasma trapping is already in place. The Z-pinch is driven by an axial current impulse between electrodes, so an alternating electric field parallel to the magnetic field is also in place. The present invention consists of placing, across the magnetic field lines, intercepting surfaces onto which ionized lithium atoms are driven by the electric field. The surfaces are covered by meshes that trap condensed lithium as a liquid and provides passages for its immediate return to the electrodes for re-use. Lithium that is leaving the discharge region is ionized by either photons, electron collisions, or charge transfer events, and the alternating electric field applied between the collection plates drives these lithium ions parallel to the said magnetic field lines and onto the plates. The ions are neutralized on impact and enter a region of liquid lithium trapped by meshes on the surface of each plate, and this liquid lithium migrates back toward the high temperature central region to be reused in the discharge.

According to a first aspect of the invention, an extreme ultraviolet light source comprises: a linear gas discharge between open-ended coaxial heat pipes stabilized by an applied coaxial magnetic field; a laser beam that is focused on and intersects the discharge; collection plates disposed perpendicular to the magnetic field and connected to the open ends of the heat pipes; meshes on the opposed surfaces of the collection plates; wherein extreme ultraviolet radiation is enhanced where laser light is absorbed in the gas discharge, and metal vapor diffusion away from the discharge is substantially prevented by ionization within the region between the collection plates followed by drift in an electric field onto the plates and reflux in the meshes to the center where it is re-used.

According to a second aspect of the invention, an extreme ultraviolet light source comprises: a linear gas discharge between open-ended coaxial heat pipes stabilized by an applied coaxial magnetic field; a laser beam that is focused on and intersects the discharge; collection plates disposed perpendicular to the magnetic field and connected to the open ends of the heat pipes; a median collector disc that can be biased relative to the open ends of the heat pipes; meshes on the opposed surfaces of the collection plates; wherein extreme ultraviolet radiation is enhanced where laser light is absorbed in the gas discharge, and metal vapor diffusion away from the discharge is substantially prevented by application of a potential to the median disc to cause ionization within the region between the collection plates and the disc followed by drift in an electric field onto the plates and reflux in the meshes to the center where it is re-used.

### BRIEF DESCRIPTION OF THE DRAWINGS

For a better understanding of the present invention, reference is made to the accompanying drawings, which are incorporated herein by reference and in which:

FIG. 1 is a schematic diagram of a first embodiment of a laser heated discharge plasma EUV source with plasma-assisted lithium reflux;

FIG. 2 is a graph of absorption length for 10.6 micron laser light as a function of plasma density;

FIG. 3 is a detail of a central region of the EUV source of FIG. 1;

FIG. 4 is a schematic diagram of a second embodiment of a laser heated discharge plasma EUV source with plasma-assisted lithium reflux;

FIG. 5 is a detail of a central region of the EUV source of FIG. 4, showing the additional disk; and

FIG. 6 is a schematic diagram of a third embodiment of a laser heated discharge plasma EUV source with plasma-assisted lithium reflux.

### DETAILED DESCRIPTION

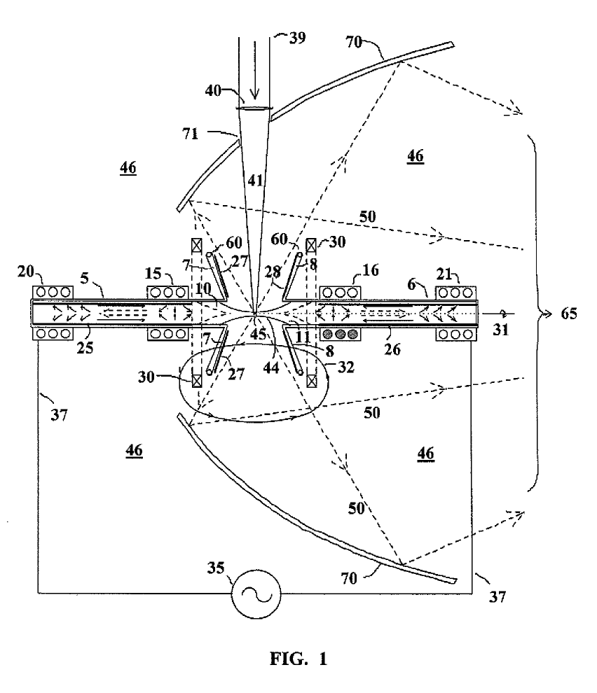

An embodiment of the invention is illustrated in FIG. 1, relating to linear coaxial Z-pinch confinement of the lithium plasma with heating by a transversely incident pulsed or continuous wave carbon dioxide laser. An axial magnetic field is applied with two principal functions. Firstly, it provides improved stability to the Z-pinch discharge against the commonly experienced “sausage” and “kink” instabilities [7], and secondly it is required as part of the plasma assisted lithium reflux mechanism to be described below.

Before describing the operation of this embodiment in detail, some general description will be given of the absorption mechanism. The carbon dioxide laser has its principal wavelength at 10.6 microns, and is reflected from a plasma of electron density greater than 10¹⁹ electrons cm⁻³. Just below this density the carbon dioxide laser radiation is strongly absorbed by a process known as inverse bremsstrahlung absorption. The absorption length is given by [8,9]:

$${L}_{ab} = \frac{5 \times {10}^{27} {T}_{e}^{3 / 2}}{{n}_{e}^{2} Z {λ}^{2}} {( 1 - \frac{{λ}^{2}}{{λ}_{e}^{2}} )}^{1 / 2}$$

where λ is the wavelength in cm, λₑ is the wavelength of radiation at the plasma electron frequency ωₑ; i.e. λₑ=2πc/ωₑ and ωₑ²=4πnₑe²/mₑ, Tₑ is the electron temperature in eV, nₑ is the electron density in cm⁻³, and Z is the ionic charge.

The laser intensity decreases with depth x into the plasma as:

I=I₀ exp(−x/L_{ab})

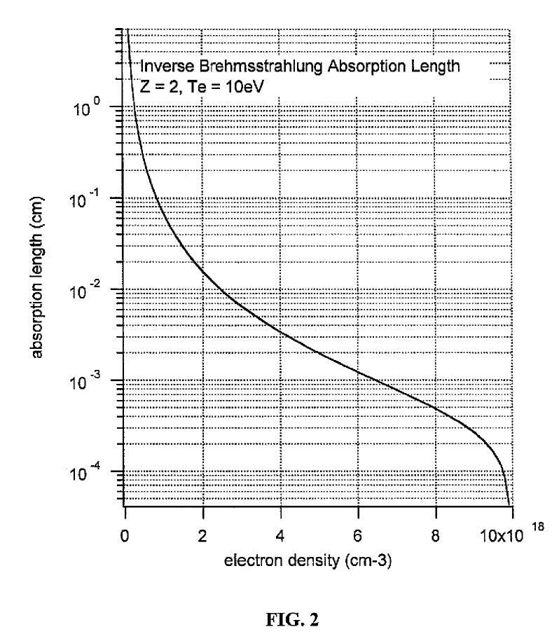

FIG. 2 shows the calculated absorption length for a typical plasma temperature of 10 eV, and average charge of Z=2, corresponding to conditions for which a significant Li²⁺ ion density is present. In that figure it is seen that a 1 mm absorption depth requires an electron density of approximately 1×10¹⁸ cm⁻³, corresponding to a lithium ion density of 5×10¹⁷ cm⁻³.

The absorbed laser energy is given initially to the plasma electrons, which thermalize into an increasingly hot Maxwellian energy distribution, until excitation increases from the ground to first excited state of the Li²⁺ ion. Re-radiation to the ground state occurs within 26 psec, with the emission of a 13.5 nm photon. The lithium ion is then available for a further cycle of excitation and radiation. The 13.5 nm extreme ultraviolet light is most intense from the absorption volume, defined by the focal spot diameter of the heating laser, and the absorption depth. This volume may therefore be tuned in shape and size to optimize illumination uniformity in lithography or another use. Provided the absorbed laser power dominates heat transport out of the absorption region by plasma thermal conduction, there will be efficient conversion of absorbed light at 10.6 μm into EUV radiation at 13.5 in occurring within a volume of approximately the same size as the absorption volume. The linear geometry of a Z-pinch, with its strong azimuthal self-field, acts as a natural heat trap, because the conduction of heat is only significant along the axis of the pinch. It may be shown that an axial heat flow of one to several kW can exist close to the laser absorption region, so the laser power should be greater than a few kW for optimum small plasma size, to avoid “smearing” by thermal diffusion.

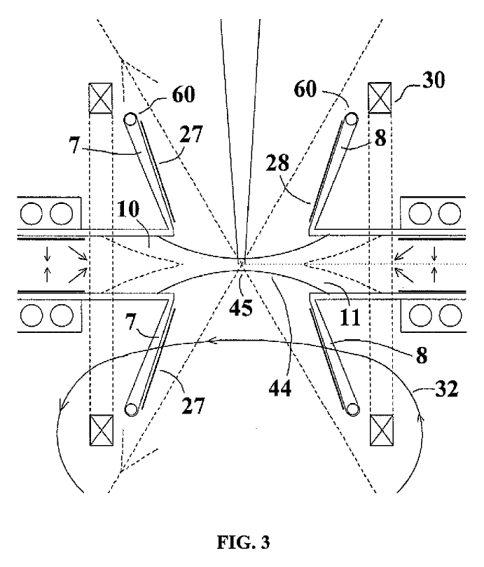

An embodiment of the invention is shown in its entirety in FIG. 1, and the central discharge region in FIG. 1 is enlarged for clarity in FIG. 3. It operates as follows: Coaxial cylindrical heat pipes 5 and 6 are aligned on axis of symmetry 31. They are opposed to each other, with open ends 10 and 11 facing each other. Attached to open ends 10 and 11 respectively are shallow conical or planar discs 7 and 8 which have rotational symmetry around axis 31. Heat pipes 5 and 6 have interior walls with meshes 25, 26 installed along most of their length in order to contain molten lithium and allow it to flow from the cooler outer end of a heat pipe to the hotter central region adjacent to central position 45. Cones or discs 7 and 8 have a meshes 27, 28 attached to the surfaces facing the center 45 of the apparatus. A charge of solid lithium is initially laid inside each of tubes 5 and 6. Heater structures 15 and 16 are disposed on the outside of each tube near the inner end of the mesh. Cooling structures 20 and 21, with water flow, are disposed around each outer end of tubes 5 and 6. Cooling tubes 60 are disposed at the outer edges of discs or cones 7 and 8. A pair of magnet coils 30, coaxially aligned with axis of symmetry 31 are energized by a current to produce a substantially constant magnetic field in the central region. Mid-way between openings 10 and 11 at position 45 on the axis, the magnetic field is aligned with axis 31. A typical magnetic field line is labelled 32 in FIG. 1. Alternating current and voltage generator 35 is connected by conductors 37 to the outer ends of each of tubes 5 and 6. Carbon dioxide laser beam 39 is focused by lens 40 to converge in focused beam 41 on an interaction region 45 within the space between openings 10 and 11. The space 46 around the components is kept under vacuum, or filled to a low pressure with an unreactive buffer gas such as helium. A collector mirror 70 of ellipsoidal cross section, with rotational symmetry around axis 31, focuses EUV radiation 50 leaving source point 45 onto intermediate focus point 65. A hole 71 in mirror 70 allows entry of the carbon dioxide laser beam.

In operation, heaters 15 and 16 are employed to raise the temperature of the inner ends of heat pipes 5 and 6 to the approximate range of 800-900 C, while cooling elements 20 and 21 and 60 continue to be at less than about 200 C. Lithium within tubes 5 and 6 melts, flows toward the center of the apparatus, and begins to evaporate from the hot regions adjacent to heaters 15 and 16. As the lithium density rises through a value of about 10¹⁵ atoms cm⁻³, an alternating voltage applied by generator 35 strikes a discharge between hollow electrodes 10 and 11. The almost complete ionization of lithium in the space between entrances 10 and 11 causes lithium to be trapped by the applied magnetic field, with slight probability of escape. Lithium atoms that escape to beyond the radius of tubes 5 or 6 enter the region between discs or cones 7 and 8, which have magnetic field lines, for example line 32, passing more or less perpendicularly to them as shown in FIG. 3, which is a detail of FIG. 1. In that region between 7 and 8 there are rapid ionizing processes, including photo-ionization by radiation from the axial pinch, and electron collisional ionization, that combine to rapidly ionize a neutral lithium atom. Once ionized, it experiences an electric field in one or other axial direction, depending upon the phase of the alternating discharge, that accelerates it toward and onto the surface of 7 or 8. Once it has struck the surface it sticks with a probability of near unity, and enters the liquid layer within surface mesh 27 or 28. Lithium within these meshes is flowing from the cooler outboard regions toward the hotter central regions in the same way as it flows from cooler to hotter in cylindrical heat pipes 5 and 6. This whole ionization capture and reflux mechanism is described as “plasma assisted lithium reflux.”

Continued heating to an inner temperature in the range of 800 C to 900 C raises the lithium density to the 10¹⁶-10¹⁷ cm⁻³ range. At this time, if sufficient alternating current is driven by generator 35, the discharge between hollow electrodes 10 and 11 constricts, (44), increasing the lithium ion density to the 5×10¹⁷ cm⁻³ range at which laser absorption is efficient in a length of about 0.1 cm. Applied current in the range of 100 Amp to 10,000 Amp causes a “pinch effect” in which the self-magnetic field of the current exerts a force on discharge electrons toward the axis of the discharge, and its diameter is reduced. As an example, a pulsed decrease in diameter from 5 mm to 1 mm yields a 25 times density increase, raising the lithium density from a quiescent value of 2×10¹⁶ cm⁻³ to 5×10¹⁷ cm⁻³. The lithium atoms are mostly doubly ionized when the plasma electron temperature is heated to about 10 eV in this density regime, so the electron density is 1×10¹⁸ cm³. Focused carbon dioxide laser beam 41 deposits its energy within a small plasma volume 45 at the waist of discharge 44, and 13.5 nm extreme ultraviolet radiation leaves volume 45 in beams 50 that encompass a large fraction of the available 4π solid angle. The carbon dioxide laser can be timed to pulse its energy at the point of maximum discharge constriction on each half cycle of generator 35. The symmetry of this configuration ensures that the lithium load in each of heat pipe tubes 5 and 6 remains approximately equal, allowing long operation before lithium depletion occurs in either tube, and consequently allowing the use of a very small lithium inventory. When the average absorbed carbon dioxide laser power becomes significant in comparison to the power in heaters 15 and 16, the latter power is reduced by a control circuit that may operate by measurement of the internal resistance of the heater elements within 15 and 16, Excess heat is then removed from the central region by heat pipe action as well as thermal conduction in the walls of tubes 5 and 6, and in the material of discs or cones 7 and 8.

Although illustrated with the carbon dioxide-lithium system of interest for 13.5 nm production, the principle described above in reference to FIG. 1 can be applied with other metal vapors and the same or other laser wavelengths, to generate other extreme ultraviolet wavelengths of interest in various applications. For example, tin vapor in a helium buffer can also be used, together with a carbon dioxide laser, to generate 13.5 nm EUV light.

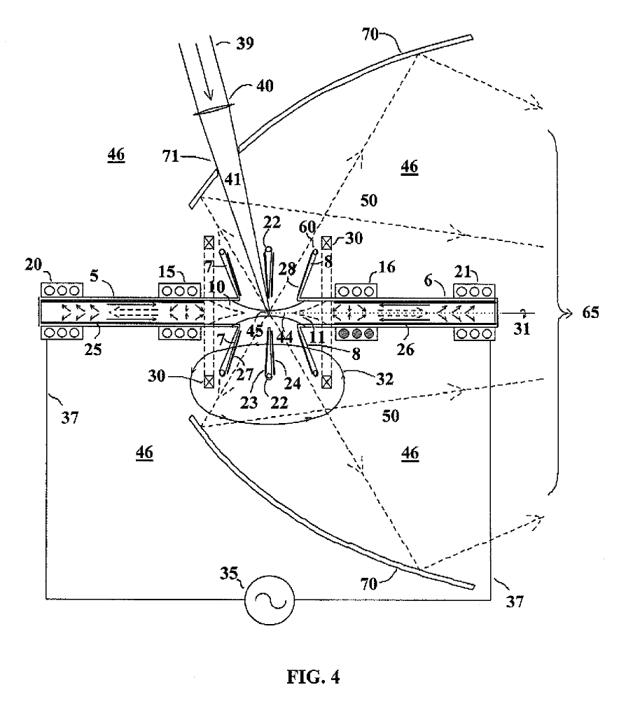

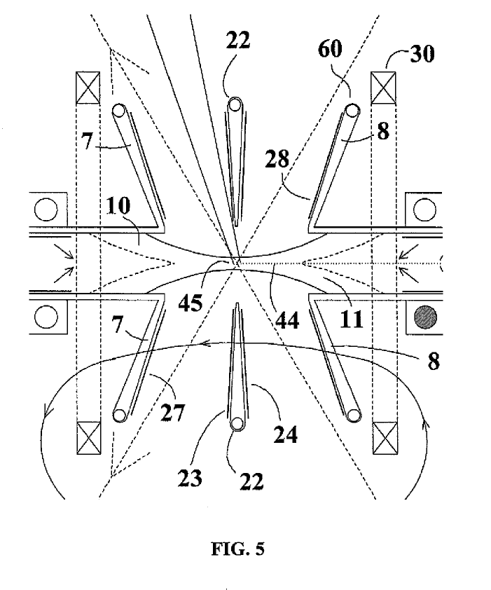

A second embodiment of the invention is shown in its entirety in FIG. 4 and the central discharge region in FIG. 4 is enlarged for clarity in FIG. 5. This is identical to the first embodiment except that there is now an added disc 22 in the median plane which can have three functions. The disc is supported by an insulator and can receive an externally applied voltage relative to either of electrodes 10,11. It can have meshes 23, 24 on both surfaces. The first function, as described in [2] is to aid ignition of the plasma discharge. The second function, relevant to the present invention, is to provide axial electric fields that both ionize lithium atoms and drive the ions toward the electrode collector plates. The third function is to transport intercepted lithium atoms toward the warmer central region for evaporation and re-use in the discharge. Operation is the same as the first embodiment, described above, with the following changes. As the metal vapor density is increasing prior to full source operation, a voltage that can be negative or positive relative to the electrodes 10,11 is applied to disc 22 so as to initiate an electric discharge between disc 22 and the electrodes. The voltage required for ignition is typically in the range 500V to 5 kV, depending on conditions.

Once pulsed operation of the Z-pinch is ongoing, a potential on disc electrode 22 can be used to ionize lithium vapor and, when biased positive relative to the electrodes, to drive lithium ions onto the collection meshes 27, 28 attached to the electrodes. The Z-pinch high current phase lasts of the order of 1 microsecond, and if repeated at, for example, 50 kHz, there is a 19 μsec interval when there is not an applied voltage to drive ions onto meshes 27,28. In order to provide active lithium recovery during the whole cycle, disc 22 is biased positive to the electrodes by several hundred volts for most of the inter-pulse duration. It is possible to aid re-ignition of the Z-pinch on each pulse by applying a momentary negative impulse to disc 22 just prior to application of a high current pulse to the electrodes. The temperature of disc 22 can be regulated via a cooling channel on its perimeter. The inner edge of the disc receives a high flow of heat from the expanding plasma, so a heater is not necessary at that location.

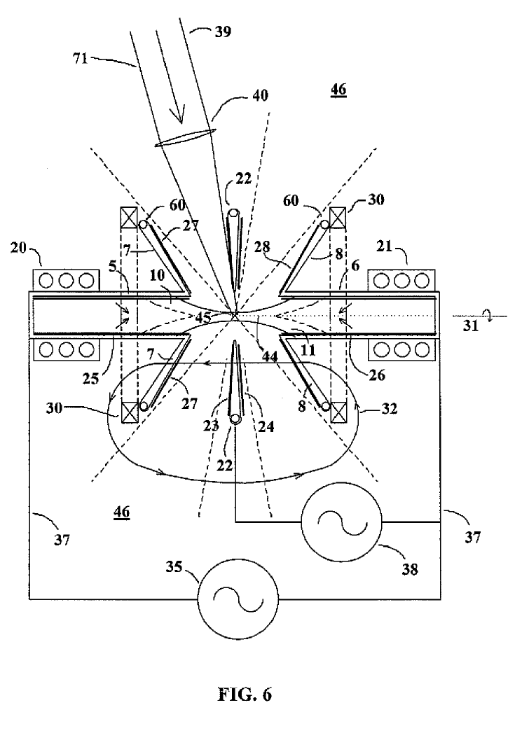

A third embodiment of the invention is illustrated in FIG. 6. This differs from the previous two embodiments in that the source of heating of the electrodes is from the discharge itself, rather than via internal heater structures. This gives greater simplicity and reliability, however, operation requires a helium buffer pressure at the outset so that the discharge can be supported during the heating phase of the electrodes, when the lithium vapor density is not yet sufficient.

With reference to FIG. 6, in operation the space 46 surrounding the electrode structure has a low (few torr) helium pressure, sufficient to support an alternating discharge between electrode tubes 5 and 6 driven by generator 35. The parts of collector plates 7 and 8, and of median disc 22 that are closest to the helium discharge are heated by the helium discharge to approximately 800 C, sufficient to mobilize lithium vapor for the Z-pinch target and enable EUV generation via laser heating in a central small region of the pinch. The outer parts of the apparatus are cooled via cooling blocks 20,21 and cooling channels 60. If necessary, the median disc can be cooled via a peripheral channel. The median disc is pulsed via voltage generator 38 so as to ionize lithium atoms and generate a driving electric field toward collector meshes 27 and 28 where condensed lithium can flow toward the center of the apparatus for re-use. The ellipsoidal EUV collector optic is not shown in FIG. 6, but may be considered to be disposed as shown in FIG. 4. After the transition to a lithium discharge has been achieved, the helium fill pressure may be reduced in order to minimize the absorption of EUV light as it propagates in the collection region 46.

### REFERENCES

1. V. Banine and R. Moors, “Plasma sources for EUV lithography exposure tools” J. Phys. D, Appl, Phys. 37, 3207-3212 (2004).
2. M. W. McGeoch, “Laser Heated Discharge Plasma EUV Source”, U.S. patent application Ser. No. 12/277,623 filed Nov. 25, 2008.
3. M. W. McGeoch, “Extreme Ultraviolet Source with Wide Angle Vapor Containment and Reflux”, U.S. Pat. No. 7,479,646 (Jan. 20, 2009).
4. G. Niimi et al., “Experimental evaluation of stopping power of high-energy ions from a laser-produced plasma by a magnetic field”, Proc. SPIE 5037, pp 370-377 (2003).
5. M. Richardson and G. Shriever, “Laser Plasma Source for Extreme Ultraviolet Lithography using a Water Droplet Target”, U.S. Pat. No. 6,377,651 (2002).
6. K. Takenoshita and M. C. Richardson, “The repeller field debris mitigation approach for EUV sources”, Proc SPIE 5037, pp 792-800 (2003)
7. M. A. Liberman et al., “Physics of High-Density Z-Pinch Plasmas”. Springer-Verlag, NY (1999).
8. T. W. Johnston and J. M. Dawson “Correct values for high-frequency power absorption by inverse bremsstrahlung in plasmas”, Phys. Fluids 16, 722 (1973).
9. J. H. Lee, D. R. McFarland and F. Hohl, “Production of dense plasmas in a hypocycloidal pinch apparatus”, Phys. Fluids 20, 313-321 (1977).

Further realizations of this invention will be apparent to those skilled in the art.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An extreme ultraviolet light source comprising:
a linear gas discharge between open-ended coaxial heat pipes stabilized by an applied coaxial magnetic field;
a laser beam that is focused on and intersects the discharge;
collection plates disposed perpendicular to the magnetic field and connected to the open ends of the heat pipes;
meshes on the opposed surfaces of the collection plates;
wherein extreme ultraviolet radiation is enhanced where laser light is absorbed in the gas discharge, and metal vapor diffusion away from the discharge is substantially prevented by ionization within the region between the collection plates followed by drift in an electric field onto the plates and reflux in the meshes to the center where it is re-used.

2. An extreme ultraviolet light source at 13.5 nm as in claim 1, based on the emission of lithium ions within the gas discharge in which a magnetically self-confined lithium plasma of electron density less than 10¹⁹ cm⁻³ is produced via a pulsed discharge and the plasma energy is increased by absorption of laser light at the wavelength of 10.6 microns, resulting in increased excitation of hydrogen-like lithium to its resonance level and increased radiation at 13.5 nm.

3. An extreme ultraviolet source as in claim 1, in which the laser beam impinges radially on the discharge, in order to define a compact emission volume of EUV light.

4. An extreme ultraviolet light source as in claim 1, in which the confined plasma is produced via an alternating discharge.

5. An extreme ultraviolet light source as in claim 1, in which a Z-pinch discharge provides the magnetically self-confined lithium plasma volume for the purpose of increasing the lithium ion density and creating a plasma density greater than 10¹⁷ electrons per cm³ at an electron temperature exceeding five electron volts.

6. An extreme ultraviolet light source as in claim 4, in which each phase of the alternating continuous discharge comprises a quiescent low current period followed by a high current period of shorter duration that pinches the plasma and increases its density and temperature in preparation for laser heating.

7. An extreme ultraviolet light source as in claim 6, in which the low current ranges from 1 Amp to 100 Amp and the high current ranges from 100 Amp to 10 kAmp.

8. An extreme ultraviolet light source as in claim 6, in which the quiescent period has a duration between 5 μsec and 50 μsec and the high current period has a duration between 500 nsec and 5 μsec.

9. An extreme ultraviolet light source comprising:
a linear gas discharge between open-ended coaxial heat pipes stabilized by an applied coaxial magnetic field;
a laser beam that is focused on and intersects the discharge;
collection plates disposed perpendicular to the magnetic field and connected to the open ends of the heat pipes;
a median collector disc that can be biased relative to the open ends of the heat pipes;
meshes on the opposed surfaces of the collection plates;
wherein extreme ultraviolet radiation is enhanced where laser light is absorbed in the gas discharge, and metal vapor diffusion away from the discharge is substantially prevented by application of a potential to the median disc to cause ionization within the region between the collection plates and the disc followed by drift in an electric field onto the plates and reflux in the meshes to the center where it is re-used.

10. An extreme ultraviolet source as in claim 9, in which the heat pipe substance is lithium and the laser is a carbon dioxide laser with principal wavelength at 10.6 microns.
